(19) United States
(12) Patent Application Publication
(10) Pub. No.: US 2017/0002552 A1
(43) Pub. Date: Jan. 5, 2017

(54) WATER PURIFYING FAUCET NOT HAVING PULL-OUT FUNCTION

(71) Applicant: Xiamen Runner Industrial Corporation, Xiamen (CN)

(72) Inventors: Jin-Fa Wang, Xiamen (CN); Xi-Min Chen, Xiamen (CN); Rong-Gui Zhang, Xiamen (CN); Ming Li, Xiamen (CN)

(21) Appl. No.: 15/188,980

(22) Filed: Jun. 22, 2016

(30) Foreign Application Priority Data
Jul. 1, 2015 (CN) 201520462394.2

(51) Int. Cl. E03C 1/04; F16K 11/02

(52) U.S. Cl. CPC E03C 1/04; F16K 11/02; E03C 1/0412

(57) ABSTRACT

A water purifying faucet not having pull-out function, comprising: a faucet main body, a dual output bend tube, a hot water input tube, a cold water input tube, a cold water output tube, a purified water input tube, a hydraulic converter, a two-input two-output valve seat, a two-input two-output valve core, a water channel tube, a connector, a central bolt, and a press plate. The two-input two-output valve seat is disposed on the faucet main body, with its two water input ports connected respectively to the hot water input tube and the cold water input tube. The water purifying faucet not having pull-out function is novel in design, easy to operate, and is capable of providing three types of water output, in meeting users' requirements effectively.

### BACKGROUND OF THE INVENTION

Field of the Invention

The present invention relates to a water purifying faucet, and in particular to a water purifying faucet not having pull-out function.

The Prior Arts

Usually, in an ordinary household, especially in a kitchen, in addition to an ordinary water faucet, a separate water purifying faucet is provided, to meet user's demand for various qualities of water. However, it this way, it could occupy additional space in the kitchen, while causing inconvenience to the user. Further, the water output from the water faucet cannot be adjusted to soft water or standard water, thus causing additional inconvenience to the user.

Therefore, presently, the design and performance of the water faucet is not quite satisfactory, and it leaves much room for improvement.

### SUMMARY OF THE INVENTION

In view of the problems and drawbacks of the prior art, the present invention provides a water purifying faucet not having pull-out function, to overcome the shortcomings of the prior art.

The present invention provides a water purifying faucet not having pull-out function, comprising: a faucet main body, a dual output bend tube, a hot water input tube, a cold water input tube, a cold water output tube, a purified water input tube, a hydraulic converter, a two-input two-output valve seat, a two-input two-output valve core, a water channel tube, a connector, a central bolt, and a press plate.

In the structure mentioned above, the dual output bend tube is connected to an upper end of the faucet main body, and having two water output ports disposed thereon. The hot water input tube is connected to a lower end of the faucet main body. The cold water input tube is connected to a lower end of the faucet main body. The cold water output tube is connected to a water input port of a water purifier. The purified water input tube is connected to a water output port of the water purifier. The hydraulic converter is disposed in the faucet main body, with its water input port connected to the purified water input tube, and with its water output end connected to a water input port of the dual output bend tube. The two-input two-output valve seat is disposed on the faucet main body, with its two water input ports connected respectively to the hot water input tube and the cold water input tube, and with its two water output ports connected respectively to the cold water output tube, and the other water input port of the hydraulic converter. The two-input two-output valve core is disposed on the faucet main body. The water channel tube is disposed on the dual output bend tube extending from its water input port to its water output port, and is connected to the water input port of the dual output bend tube. The connector is disposed on the dual output bend tube extending from its water input port to its water output port, and is located between a water output port of the water channel tube, and the water output port of the dual output bend tube. The central bolt is disposed in a central portion of the water channel tube, and is controlled by a first push button, to control direction of water flow; and the press plate is disposed in a water channel, to hinge with a rotation pin, with one end of the press plate connected to the central bolt, with its other end connected to a second push button, connecting to the water channel tube.

In an aspect of the present invention, the hydraulic converter includes a shell disposed in the faucet main body, while the central bolt disposed in the shell.

In another aspect of the present invention, the water purifying faucet not having pull-out function further comprises: a handle, disposed on the faucet main body, used to drive the two-input two-output valve core.

In yet another aspect of the present invention, the water purifying faucet not having pull-out function further comprises: a water softener, disposed in one of the water output ports of the dual output bend tube.

In a further aspect of the present invention, the water purifying faucet not having pull-out function further comprises: a barrel-shape panel, disposed in a through hole to form two water output ports of the dual output bend tube, while the through hole is disposed on a water output side of the dual output bend tube.

The advantage of the present invention is that, the water purifying faucet not having pull-out function is novel in design, easy to operate, and is capable of providing three types of water output, in meeting users' requirements effectively.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a perspective view of a water purifying faucet not having pull-out function according to an embodiment of the present invention;

FIG. 2 is an exploded view of a water purifying faucet not having pull-out function according to an embodiment of the present invention;

FIG. 3 is a cross section view of a water purifying faucet not having pull-out function according to an embodiment of the present invention; and

FIG. 4 is another cross section view of a water purifying faucet not having pull-out function according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

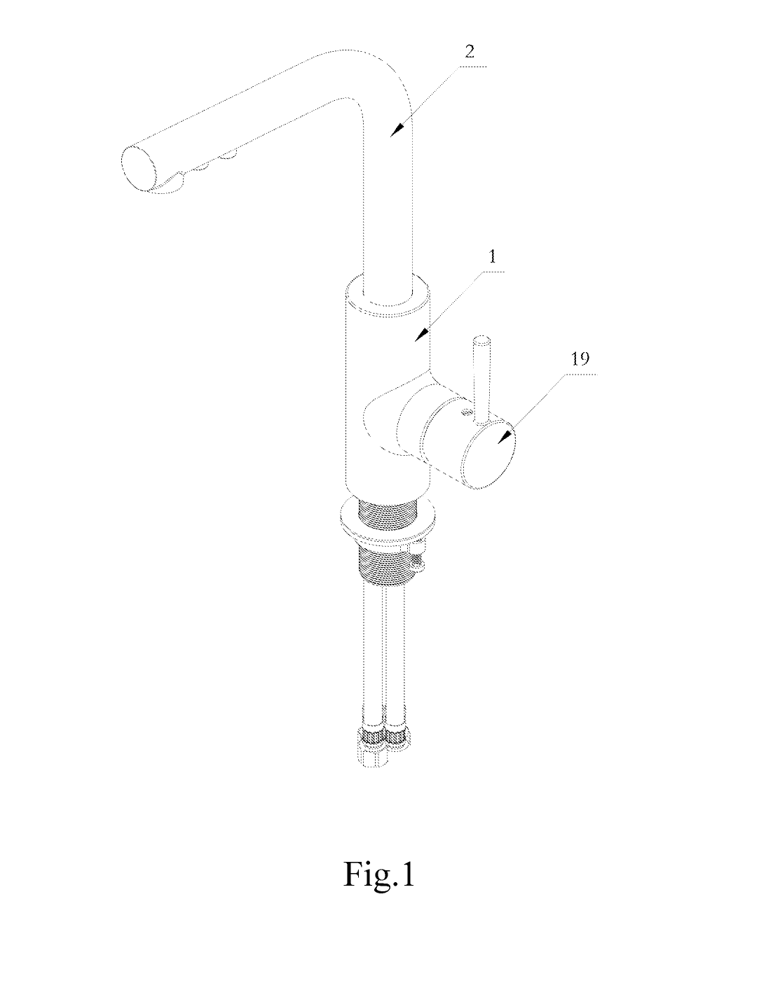

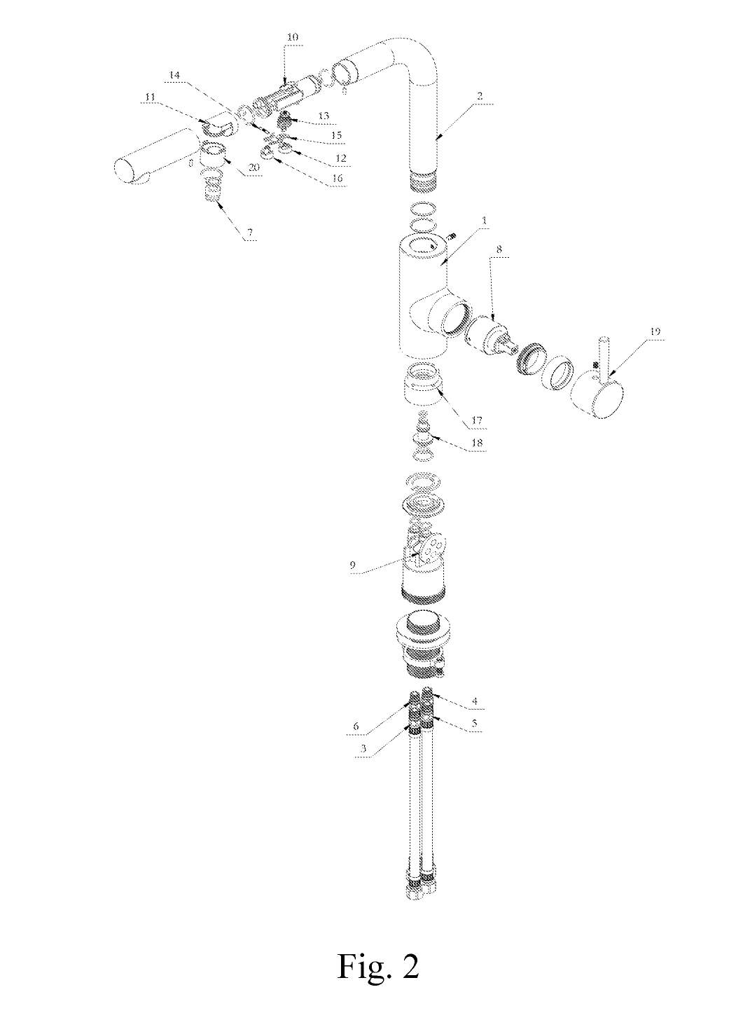

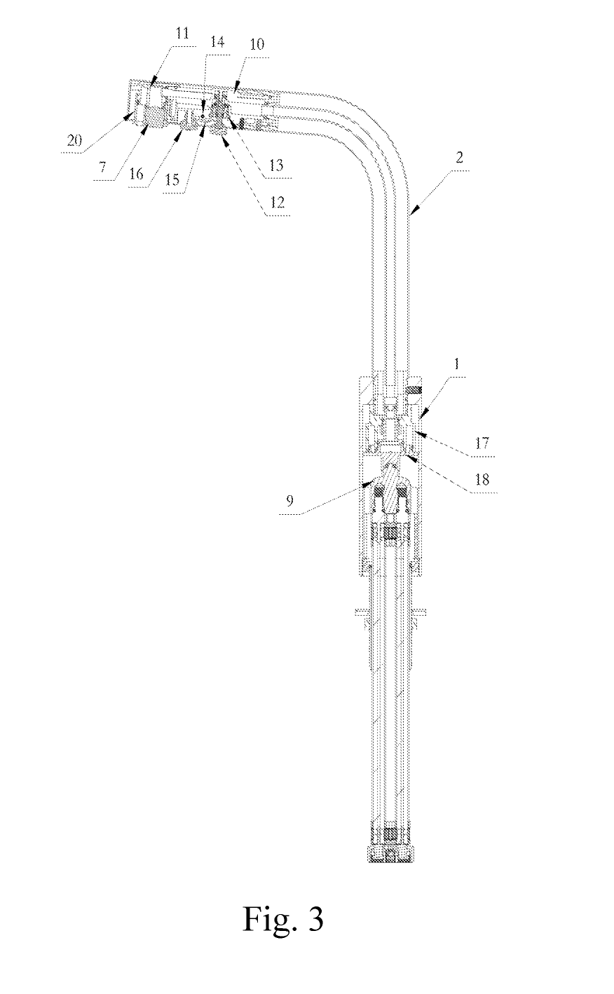

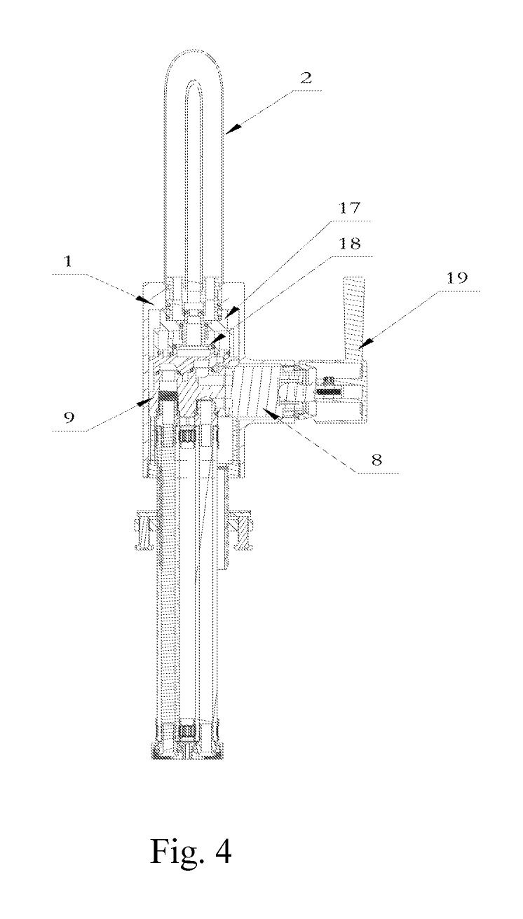

Refer to FIGS. 1 to 4 respectively for a perspective view of a water purifying faucet not having pull-out function according to an embodiment of the present invention; an exploded view of a water purifying faucet not having pull-out function according to an embodiment of the present invention; a cross section view of a water purifying faucet not having pull-out function according to an embodiment of the present invention; and another cross section view of a water purifying faucet not having pull-out function according to an embodiment of the present invention.

As shown in FIGS. 1 to 4, the present invention provides a water purifying faucet not having pull-out function, comprising: a faucet main body 1, a dual output bend tube 2, a hot water input tube 3, a cold water input tube 4, a cold water output tube 5, a purified water input tube 6, a hydraulic converter, a two-input two-output valve seat 9, a two-input two-output valve core 8, a water channel tube 10, a connector 11, a central bolt 13, and a press plate 15.

In the structure mentioned above, the dual output bend tube 2 is connected to an upper end of the faucet main body 1, and having two water output ports disposed thereon. The hot water input tube 3 is connected to a lower end of the faucet main body 1. The cold water input tube 4 is connected to a lower end of the faucet main body 1. The cold water output tube 5 is connected to a water input port of a water purifier. The purified water input tube 6 is connected to a water output port of the water purifier. The hydraulic converter is disposed in the faucet main body 1, with its water input port connected to the purified water input tube 6, and with its water output end connected to a water input port of the dual output bend tube 2. The two-input two-output valve seat 9 is disposed on the faucet main body 1, with its two water input ports connected respectively to the hot water input tube 3 and the cold water input tube 4, and with its two water output ports connected respectively to the cold water output tube 5, and the other water input port of the hydraulic converter. The two-input two-output valve core 8 is disposed on the faucet main body 1. The water channel tube 10 is disposed on the dual output bend tube 2 extending from its water input port to its water output port, and is connected to the water input port of the dual output bend tube 2. The connector 11 is disposed on the dual output bend tube 2 extending from its water input port to its water output port, and is located between a water output port of the water channel tube 10, and the water output port of the dual output bend tube 2. The central bolt 13 is disposed in a central portion of the water channel tube 10, and is controlled by a first push button 12, to control direction of water flow. The press plate 15 is disposed in a water channel, to hinge with a rotation pin 14, with one end of the press plate 15 connected to the central bolt 13, with its other end connected to a second push button 16, connecting to the water channel tube 10.

The hydraulic converter includes a shell 17 disposed in the faucet main body 1, while the central bolt 18 disposed in the shell 17.

The water purifying faucet not having pull-out function further comprises a handle 19, disposed on the faucet main body 1, used to drive the two-input two-output valve core 8.

The water purifying faucet not having pull-out function further comprises: a water softener 7, disposed in one of the water output ports of the dual output bend tube 2.

The water purifying faucet not having pull-out function further comprises a barrel-shape panel 20, disposed in a through hole to form two water output ports of the dual output bend tube 2, while the through hole is disposed on a water output side of the dual output bend tube 2.

In the following, the operations of the water purifying faucet not having pull-out function are described in detail.

In operation, the hot faucet water and cold faucet water flow in from the hot water input tube and cold water input tube, and then they flow through the two-input two-output valve core 8, by passing through the two-input two-output valve seat 9. The two-input two-output valve core 8 controls the water output of the mixed water and the cold water, and it also controls the temperature and open/close of the mixed water. Meanwhile, the valve core is capable of controlling the cold water at one end to branch to a cold water output end, so that cold water flows through the cold water output tube, and that is connected to a water purifier. After the cold water is filtered through the water purifier, it flows in the purified water input tube. The two water output holes on the upper end of the valve core are mixed water output hole, and purified water output hole, such that water output from these two output holes will flow through a converter, namely a hydraulic converter, and a push button on its end is used to control output of mixed water and purified water. Through the control of the hydraulic converter, water output from one of its ends will flow into a water channel through the dual output bend tube, in realizing the function of switching among ordinary water, soft water, and purified water.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A water purifying faucet not having pull-out function, comprising:
a faucet main body;
a dual output bend tube, connected to an upper end of the faucet main body, and having two water output ports disposed thereon;
a hot water input tube, connected to a lower end of the faucet main body;
a cold water input tube, connected to a lower end of the faucet main body;
a cold water output tube, connected to a water input port of a water purifier;
a purified water input tube, connected to a water output port of the water purifier;
a hydraulic converter, disposed in the faucet main body, with its water input port connected to the purified water input tube, and with its water output end connected to a water input port of the dual output bend tube;
a two-input two-output valve seat, disposed on the faucet main body, with its two water input ports connected respectively to the hot water input tube and the cold water input tube, and with its two water output ports connected respectively to the cold water output tube, and the other water input port of the hydraulic converter;
a two-input two-output valve core, disposed on the faucet main body;
a water channel tube, disposed on the dual output bend tube extending from its water input port to its water output port, and connected to the water input port of the dual output bend tube;
a connector, disposed on the dual output bend tube extending from its water input port to its water output port, and located between a water output port of the water channel tube, and the water output port of the dual output bend tube;
a central bolt, disposed in a central portion of the water channel tube, and controlled by a first push button, to control direction of water flow; and
a press plate, disposed in a water channel, to hinge with a rotation pin, with one end of the press plate connected to the central bolt, with its other end connected to a second push button, connecting to the water channel tube.

2. The water purifying faucet not having pull-out function as claimed in claim 1, wherein the hydraulic converter includes a shell disposed in the faucet main body, while the central bolt disposed in the shell.

3. The water purifying faucet not having pull-out function as claimed in claim 1, further comprising: a handle, disposed on the faucet main body, used to drive the two-input two-output valve core.

4. The water purifying faucet not having pull-out function as claimed in claim 1, further comprising: a water softener, disposed in one of the water output ports of the dual output bend tube.

5. The water purifying faucet not having pull-out function as claimed in claim 1, further comprising: a barrel-shape panel, disposed in a through hole to form two water output ports of the dual output bend tube, while the through hole is disposed on a water output side of the dual output bend tube.
